(19) United States
(12) Patent Application Publication
(10) Pub. No.: US 2012/0227327 A1
(43) Pub. Date: Sep. 13, 2012

(54) SAFETY DEVICE AGAINST ACCIDENTS WHEN CLOSING DOORS AND WINDOWS

(76) Inventor: Ahmed Sabar, Casablanca (MA)

(21) Appl. No.: 13/138,509

(22) PCT Filed: Sep. 25, 2009
(86) PCT No.: PCT/MA2009/000019

§ 371 Date: Aug. 24, 2011

(30) Foreign Application Priority Data
Sep. 26, 2008 (CA) 2640130

(51) Int. Cl. E06B 7/36

(52) U.S. Cl. 49/383

(57) ABSTRACT

This invention aims to remedy the risks associated with finger injuries when accidentally closing doors and windows and where victims are usually small children.

It consists of the implementation of a preventive and safe device that operates in a similar fashion like a spiral notebook, thus preventing the fingers from being accidentally inserted in the rabbet between the leaf and the frame.

This device consists of two parts: a strip fixed on the internal surface of the leaf and coils that penetrate through openings in channels made in the frame.

When the leaf is closed, the coils use the channels in the frame; when opened, the coils come out of the channels and thus prevent the fingers from being inserted in the rabbet between the leaf and the frame.

This invention consists of the implementation of a preventive device against accidents related to the closing of doors and windows, where fingers get pinched in the high-risk areas inside the hinge.

The long exposed rabbet, combined with the high pressure exerted by the door or the window being closed, is behind the most frequent accidents of finger jamming and the most serious injuries.

The already-existing prevention methods are implemented outside the external surface of the rabbet. The results were both unaesthetic and cumbersome. However, the current device works just like a spiral notebook and is installed in the internal surface of the rabbet after the frame has been adjusted accordingly. Once the leaf is open, the coils spring from frame and thereby prevent the fingers from being inserted in that area. On the other hand, when the leaf is closed, the coils go into the frame. Therefore, we achieve a practical, esthetic and wieldy result.

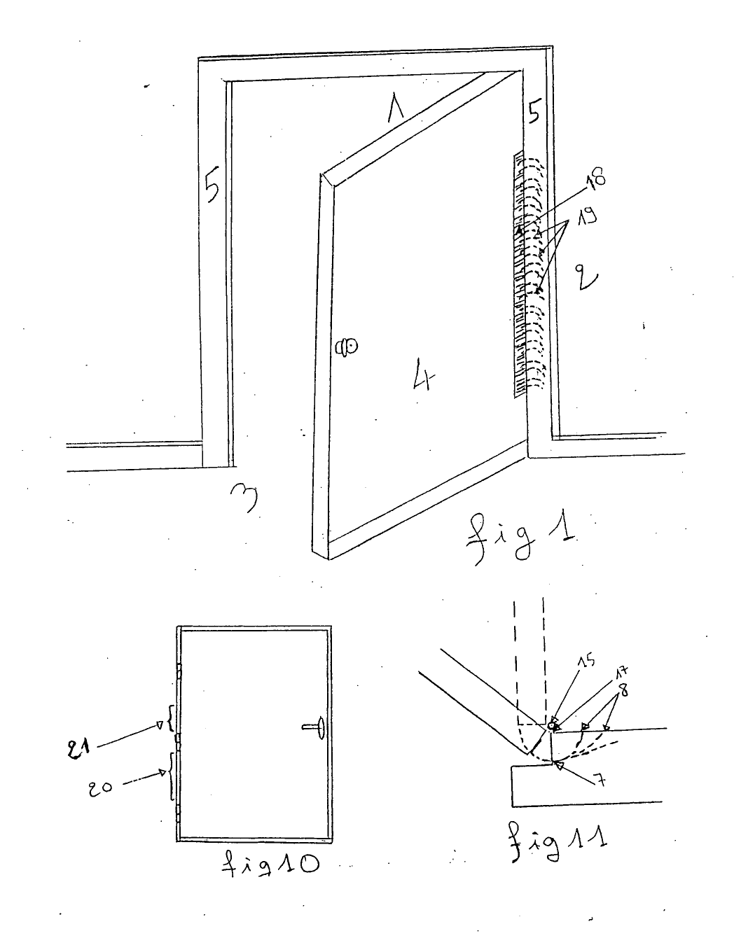

FIG. 1: Shows a front view of the coil installed on the door.

FIG. 2: Shows the coil's layout through a horizontal section of the door.

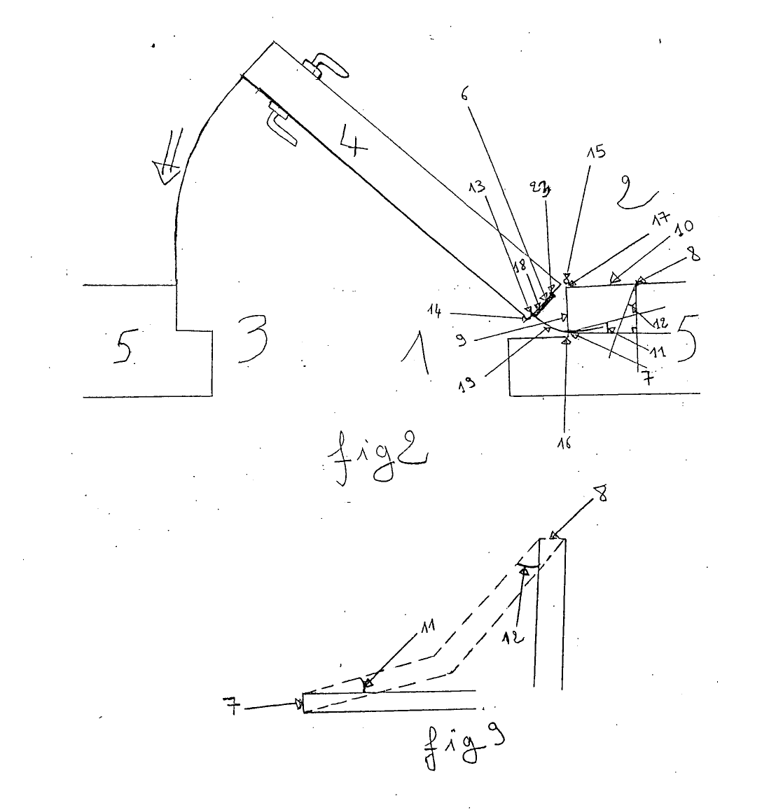

FIG. 3: The horizontal section shows the trajectory of a coil designed for a door that can be opened up to 180°.

FIG. 4: The horizontal section shows a trajectory of the coil designed for a door that can open up to 90° and the way the cover is installed.

FIG. 5: Shows in a horizontal section the second layout of a single-opening channel.

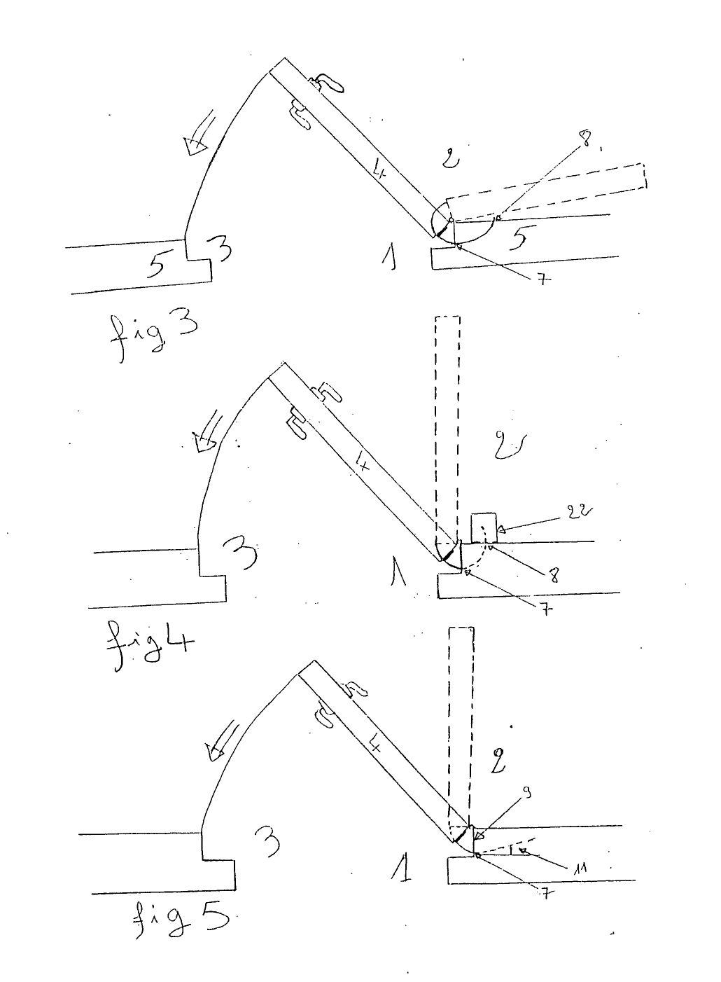

FIG. 6: The side view shows the frame's side including the openings and the channels.

FIG. 7: A side view of the coil, consisting of section A (the strip) and section B (the coils).

FIG. 8: Shows various coil shapes, rectangular, double-thread and single-thread coils, as well as rectangular, round and oval openings.

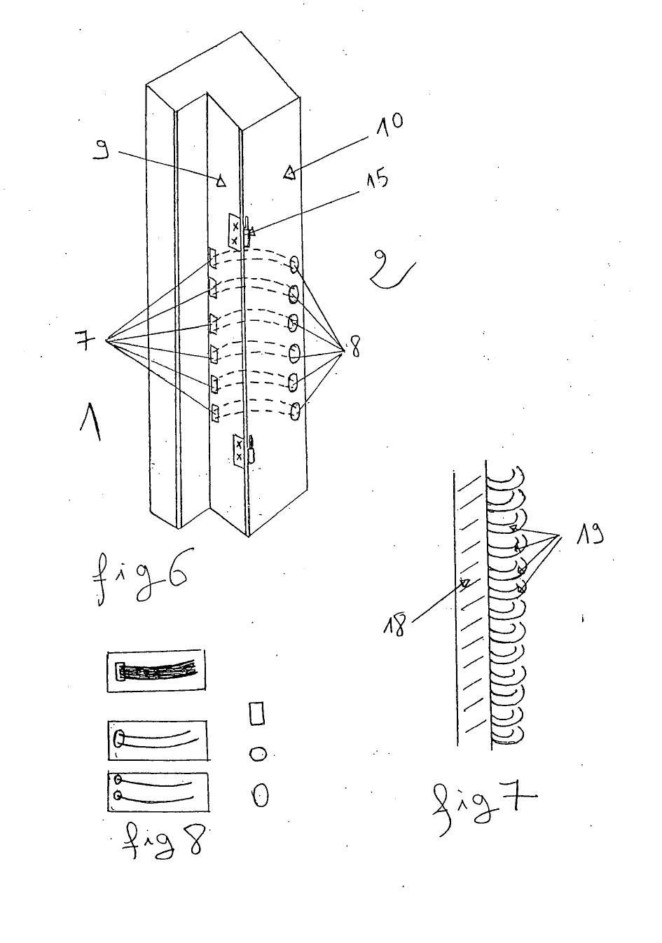

FIG. 9: The horizontal section shows the openings and the angles which enable the channels to bend.

FIG. 10: The front view of the door shows the high-risk areas both for children and adults.

FIG. 11: The horizontal section shows the various layouts in which coil channels can be made.

1. The rabbet-side of the door.

2. The hinge-pin-side of the door.

3. The handle-side of the door.

4. The leaf.

5. The frame.

6. The leaf's face from the rabbet-side.

7. An opening in the frame's face, from the rabbet-side, including the hinge's suspension mechanism.

8. An opening in the frame's face from the hinge-side.

9. The frame's face: from the rabbet-side, including the hinge's suspension mechanism.

10. The frame's face from the hinge-side.

11. The angle between the straight line passing through the opening 7 in the horizontal surface, perpendicular to the frame's face (9) and the inclination line made in the horizontal surface towards the hinge-side in order to allow the coils' channels to bend.

12. The angle between the straight line passing through the opening 8 in the horizontal surface and perpendicular to the face 10 of the frame 5, and the inclination line in the horizontal surface toward the rabbet-side in order to allow the coils' channels to bend.

13. The edge of the coil's strip located on the external side of the rabbet in the opposite direction of the hinge.

14. The edge of the leaf's face (6) on the rabbet-side.

15. The hinge

16. The edge of the frame' face (9) on the rabbet-side.

17. The edge of the frame's faces (9) and (10) on the hinge-pin-side.

18. The coil's strip

19. The coils

20. High-risk area for children at the level of the door.

21. High-risk area for adults at the level of the door.

22. The cover

23. The edge of the coil's strip located at the internal side of the rabbet towards the hinge.

The coil device constitutes one block, made of materials which are resistant and have a good yield point (e.g. steel, aluminum, plastic, titanium or other). It consists of two parts:

Part A: a strip bonded or fixed on the face 6 of the leaf 4 on the rabbet-side 1 (FIG. 1).

The length of this strip 18 (FIG. 7) is meant to cover the door area that represents a high risk for children 20 and adults 21 (FIG. 10).

As for the windows, the strip's length depends on the high-risk areas following the location and the model of the window.

The thickness of the strip 18 varies from 0.2 mm to 1 mm in a way that will enable the leaf to close normally. If we make a notch on the face 6 of the leaf 4 or on the face 9 of the frame 5 on the rabbet-side, the strip's thickness increases.

The strip is flat, adheres and moulds perfectly to the face 6 of the leaf 4 on the rabbet-side 1. It will take up the whole face or just part of it. The width varies from 1 cm to 3 cm, the distance between 13-23 (FIG. 2).

Part B: consists of coils in extension of the strip 18.

These coils are designed in different shapes: rectangular plate, double or single-threaded (Cf. FIG. 8). The choice of the shape depends on the material of which the coil has been made (aluminum, steel, plastic, titanium or other)

The distance between the coils is about 1 cm in areas with a high risk for adults 21 and about 0.4 cm in areas with a high risk for children 20.

The preparation of the channels is achieved through two layouts:

In the first layout, the channels consist of two openings each (7 and 8), located on faces 9 and 10 of the frame 5 on the rabbet-side 1 (face 9) at the level of the hinge-pin-side 2 (face 10).

These openings have been designed in round, rectangular and oval shapes, with sufficient dimensions in order to allow the free motion of the coils (FIG. 8).

The length of the channels depends on the parameters of:
The location of opening 8; thus, the more the distance, separating opening 8 from the edge 17 of the face 10 of the frame 5 on the hinge-pin-side 2, is increased, the bigger is the channels' length (FIG. 11)
Angle 11: the making of a channel starts with a breach in the opening 7 located on the face 9 of the frame 5 on the rabbet-side 1. In the beginning, this breach is done in a straight line on the horizontal surface and perpendicularly to the surface of the face 9. Afterwards, we proceed with an inclination in the horizontal surface towards the edge of the hinge-pin 2 so that the channels can bend. Angle 11 measures the degree of this inclination. The bigger is the angulation, the smaller is the length of the channels.
Angle 12: the breach in the opening 8 starts in a straight line in the horizontal surface perpendicularly to the surface of the face 10, followed by an inclination in the horizontal surface towards the rabbet. Angle 12 measures the degree of this inclination. The bigger the angle, the smaller is the length of the channels.

The length of the channels necessary to host the coils of a leaf that can be opened only up to 90° is smaller than the coils of a leaf that can be opened unlimitedly to 180° (Cf. FIG. 3, FIG. 4).

Angles 11 and 12 enable the channels to bend, which facilitates the coils' motion.

The leaf makes a rotary movement around the hinge. It is preferable that the channels have a bending similar to the arc of the circle corresponding to the rotary movement of the leaf (FIG. 4).

If the bending of the channels is modified in order to increase their length, the coils shall be made of material which has a high yield point.

In the second layout, the channels consist of one opening 7, located on the face 9 of the frame 5 on the rabbet-side 1.

The channel is a hole designed in a straight line in the horizontal surface, inclined in accordance with angle 11, thus allowing it to host the coil without touching the face 10 of the frame 5 on the hinge-pin-side 2.

The channel is made on the frame and can reach the wall (FIG. 5).

This layout yields a better esthetic result given that there is no opening 8; however, it requires the use of coils with strong mechanical property materials (high yield point).

The strip is fixed and bonded on the face 6 of the leaf 4.

The edge 13 of the strip 18, which enables the coils' extension 19, is placed on the edge 14 of the leaf 4, on the frame-side.

The distances 13-14 and 7-16 have been designed small in order to prevent the fingers from being inserted in this space.

The coils are introduced at the level of the face 9 of the frame 5, on the rabbet-side 1 with the help of the openings 7. When the leafs are opened and closed, the coils' motion inside the channels is made possible thanks to the bending created by angles 11 and 12.

In case the frame's size makes it impossible to make channels long enough and if we have a leaf that may be opened up to 180°, the ends of the coils come out of the opening 8. In order to improve the esthetic result, we shall install a hollow box cover 22 (FIG. 4) having a parallelepiped or cylinder form.

1) The safety device against accidents when closing doors and windows consists of two parts, the first being a strip 18 fixed on face 6 of the leaf 4, on the rabbet-side 1; and the second consists of coils 19 in extension of the strip 18 by the edge 14 of the face 6 of the leaf 4, accessing through the openings 7 in the two-opening channels 7-8 and single-opening channels 7 made on the frame 5.

2) Pursuant to claim 1, the device is made of material which is both hard-wearing and characterized by a high yield point (steel, aluminum, plastic, titanium or other.)

3) Based on claim 1, the device's strip 18 has a variable thickness, between 0.2 mm to 1 mm, and allows the normal closing of the leaf 4. This is important in case we make a notch on the face 6 of the leaf 4 or on the face 9 of the frame 5, on the rabbet-side 1 in order to fix this strip 18.

4) According to claim 1, the device is characterized by the fact that the strip 18 is flat, its width ranging from 1 to 3 cm or more, partially or totally adhering to the surface of the face 6 of the leaf

5) Based on claim 1, the device's strip 18 is fixed with glue and/or a screw.

6) According to claim 1, the length of device's strip 18 corresponds to children's and adults' high-risk areas, 20 and 21 respectively, and to the windows' high-risk areas as well.

7) Further to claim 1, the device's coils 19 are rectangular, double or single-threaded and the distance between the coils is around 1 cm for adults' high-risk areas 21 and around 0.4 cm for children's high-risk areas 20.

8) Based on claim 1, the length and bending of the device's two-opening channels, 7 and 8, vary according to the value of the angles, 11 and 12, and the position of the openings, 7 and 8.

9) According to claims 1 and 8, the device's coils 19 use double-opening channels, 7 and 8, which are very long, have a low bend; single-opening channels 7 are made of high-yield materials.

10) Based on claims 1 and 8, the device's coils 19 use double-opening channels, 7 and 8, which are short, have a high bend and are made of medium-yield materials

11) According to claim 1, the device has a parallelepiped or cylinder-shaped cover 22, located at the level of opening 8 destined for the coils which use double-opening channels, 7 and 8, and which come out of opening 8.

12) Further to claim 1, the width of double-opening channels, 7 and 8, and single-opening channels, 7, is large enough to allow the smooth movement of the coils 19.

13) Based on claim 1, the making of double-opening channels, 7 and 8, having a low bend, and the making of single-opening channels, 7, can reach the wall if the width of the frame 5 is not big enough to host the coils 19.
